(19) United States
(12) Patent Application Publication
(10) Pub. No.: US 2008/0235630 A1
(43) Pub. Date: Sep. 25, 2008

(54) Internet based seamless appearing transition method

(76) Inventor: John A. Kenney, Oklahoma City, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 11/724,687

(22) Filed: Mar. 15, 2007

(51) Int. Cl. G06F 3/048

(52) U.S. Cl. 715/851

(57) ABSTRACT

This invention relates generally a method for seamless appearing movement in a digitally created environment such that a computer operator has a sensation of movement within reality. Digitally traversing between and within digital images appears seamless to the computer operator. The digitally created environment provides for segmented and subsets of segmented digital images with embedded interactive links providing seamless links to other locations, information, shopping and advertising. Segmentation and subsets of segmentation facilitate rapid changes to the digital environment.

### BACKGROUND OF THE INVENTION

This invention relates to a method for moving in a seamless appearing manner between digital images within a digital environment to provide a computer operator with the sensation of physical movement in a real environment. One aspect of this invention is for a computer operator to be able to move and interact as if they were in a real environment. The computer operator moves through a city, selects a business, museum, governmental building or any other type of structure and enters it. The computer operator has the sensation of seamlessly entering the selected structure, and if the structure is a retail business, the computer operator will be able to begin shopping. This action occurs from the computer operator's distant location, yet retains the visual appearance of seamlessly occurring in the real environment.

Ongoing efforts to integrate interactive mapping with three-dimensional digital images are being pursued by several companies. Existing patents and ongoing efforts are being pursued to create an interactive virtual shopping experience for online shoppers. However, no method exists for integrating the interactive three-dimensional mapping with the interactive shopping to provide a smooth and seamless visual experience for the computer operator. Further, no capability exists to integrate the interactive mapping with an interactive structure such as a museum or monument and provide the computer operator a smooth and seamless visual experience. No capability exists to allow seamless browsing of cities, malls, retail districts, museums, entertainment districts and other such structures from a computer. This invention solves these shortfalls.

In view of the foregoing shortcomings, there is the need for an improved, seamless transition method that is integrated with interactive digital imagery such as interactive shopping. The same need for this method is found in non-shopping venues such as museums, monuments and entertainment facilities to facilitate education, information and tourism; all while providing a seamless or seamless appearing interactive process.

### SUMMARY OF THE INVENTION

The preferred embodiment is for a seamless web-imaging transition method. The method involves viewing the digital environment via an internet or computer-based network link. The digital environment is an image of a real environmental location. Within the digital environment, there is a plurality of digital structural images. Each structural image has discernible and readily identifiable characteristics indicating the physical exterior of an existing or planned structure. Within the digital images, at least one of the digital images has an interactive element within it. The computer operator “walks-through” or traverses the digital environment in a continuous manner. The transition appears to be a visually seamless motion whenever the computer operator is moving through the digital environment. Further, any animation, motion or movement on the part of the digital environment can also appear seamless to the computer operator, such as animated advertising and signs. While traversing the digital environment, the computer operator is able to move and perceive an integrated, realistic appearing environment with a view in all or nearly all directions relative to the computer operator.

This inventive method seamlessly integrates online shopping methods with online mapping. This inventive method also seamlessly integrates test marketing of a new or modified business or facility with online mapping and digital imagery, both which make up a digital environment. Additionally, this inventive method seamlessly integrates advertising and leasing of all or part of a digital image within an integrated digital environment.

This invention provides a novel method to maintain the traditional feel of shopping within a local store within the world of the internet. Several key cornerstones of the traditional retail store are retained and others are enhanced. These cornerstones include the store's trade dress, logo(s), product placement, advertising, impulse product placement and convenience of inspecting the products prior to purchasing them. These can be integrated with internet online shopping methods such as reviewing identified images of products. The added benefit is an ease of access for a larger population without requiring physical travel to visit the actual location. A further benefit is that the traditional store now has the ability to provide an online presence. The feel and experience of being in the physical store is retained to include almost all of the sights and potentially many of the sounds. In addition to the shopping experience, this invention allows the computer operator to view a business, museum, mall, store, entertainment complex, large structural complex and any other structure with the same interactive feel found in the physical world. The computer operator visually perceives the digital environment as if they were actually moving about in the real environment.

The preferred embodiment provides a seamless web imaging transition method. The method involves viewing the digital environment via an internet or computer based network link. The digital environment is an image of an actual location. Within the digital environment, there is a plurality of digital structural images. Each structural image has discernible and readily identifiable characteristics indicating the physical exterior of an existing or planned structure. Within the digital images, at least one of the digital images has an interactive element within it. The computer operator “walks-through” or traverses the digital environment in a continuous manner. The transition appears to be a visually seamless motion whenever the computer operator is moving through the digital environment. Further, any animation, motion or movement on the part of the digital environment can also appear seamless to the computer operator, such as animated advertising and signs. While traversing the digital environment, the computer operator is able to move and perceive an integrated realistic appearing environment with a view in all or nearly all directions relative to the computer operator.

The computer operator is able to browse the digital environment until finding something of personal interest. Upon finding something of interest, the computer operator selects one of the interactive digital structural images. In a visually seamless appearing manner, the computer operator moves through the interactive entryway into the interactive digital structural image. The interior of the digital structural image appears as the interior appears in a real store, mall, museum or similar structure. Preferably, the computer operator sees a plurality of interactive images within the digital structure which are interactively selectable. If shopping, many shoppers may choose not to browse and prefer the ability to quickly access the store's catalog or other internet shopping method via a quick link. At a point the computer operator will choose to continue or exit. Upon completion of activities within the digital structure's interior, the computer operator may exit through the any available point. The computer operator continues to perceive a seamless appearing visualization of the interactive entryway and the digital environment.

Another advantage of this invention is that the digital images may easily include advertising. Within the preferred embodiment, interactive advertising is inserted into individual segments and seamlessly appears to be part of the digital image. Advertising may be in the form of a traditional advertisement found throughout a city such as billboards, signs, electronic marquees and other common advertising means. The advertising may be in the form of animation to include scrolling marquees, flashing signs, video, audio and other such means as may be embedded within a digital image. Each of these advertisements would preferably include an electronic link to the website or business advertising. It is also preferred that within the individual structures themselves, a subset of advertising is also included. The subset of advertising may include product placement advertising, specials within the store or any other form of advertising commonly seen in a retail environment. The subset of advertising facilitates impulse purchasing by the computer operator. An extension of the advertising to a non-retail establishment is also considered as part of this invention.

Therefore, from the foregoing, it is a general objective of the present invention to provide a novel and improved internet-based seamless appearing transition method for a digitally-based transition between and within digital images. Further objectives, features and advantages of the present invention will be readily apparent to those skilled in the art when the following description of the preferred embodiments is read in conjunction with the accompanying drawings.

### BRIEF DESCRIPTION OF THE DRAWINGS

FIG. 1—Is a perspective view of the digital environment.

FIG. 2—Is a view from a computer operator's perspective as the computer operator is preparing to enter an individual structure from the digital environment and perceiving a partial interior of the individual structure.

FIG. 3—Is a view from a computer operator's perspective as the computer operator perceives the inside of an individual structure which happens to be a retail store.

### DETAILED DESCRIPTION OF THE PREFERRED EMBODIMENTS

### Overview

Digital camera images, digital video images, digitized images or artificially created images and video provide the background for the seamless appearing transition through a digital environment. The present invention captures the seamless appearing integration of a plurality of digital images, regardless of the means of creation, and the ability to traverse through the environment resulting from the integration of those same images. Creating a digital environment of an existing location is the initiation of the process. This method takes two- and three-dimensional images and combines them with other digital images to create a realistic appearing environment. Several different companies and individuals are creating two- and three-dimensional digital images of cities, monuments and other physical structures. Some of the images are digital video and others are digital stills. Missing digital images may be added to the existing digital imagery. The composite digital environment is a realistic appearing environment of an existing physical location. A representative example of a visit to New York City is presented herein.

An example of a person walking in a city is used to assist in understanding this invention. A person traversing a city street is able to view the realistic appearing environment. The person may select a particular structure to enter as they are traversing the street. Upon entering that structure, the person experiences the transition through a doorway. The volume of the interior of the structure is exposed to the person as they walk through the door. The entire experience for the person in reality is a seamless and continuous experience. This invention creates a similar experience for the computer operator by using digital images.

Many national retailers produce their websites at the corporate headquarters. The headquarters' websites are oriented towards the headquarters. Very little of the headquarters-based websites include local “brick and mortar” store unique qualities. Many of the “brick and mortar” stores of a national retailer may have a different exterior and/or a different interior. This inventive method provides for the integration of the national retailer website with the local “brick and mortar” store. The shopper experiences the familiarity of the local store while being able to take advantage of the national retailer's larger volume on the nationally-based website. This method provides a more familiar feel to the shopping. Shoppers are able to identify their local store from the digital environment based upon the exterior appearance.

### Preferred Embodiment of Method

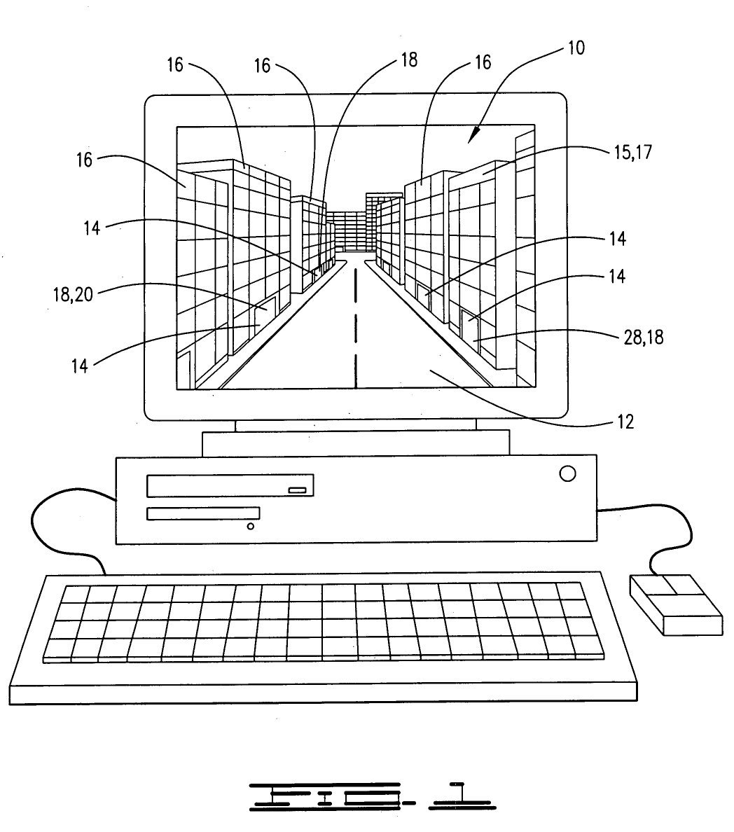

A digital environment 10 in accordance with this invention is shown by FIG. 1. A seamless transition method begins with digital environment 10. In FIG. 1, digital environment 10 is represented by a street 12 with a plurality of shops 14. Digital environment 10 is preferably a realistic appearing environmental image of a real, existing location. FIG. 1 represents an image that a computer operator might see of digital environment 10 via an electronic link. Digital environment 10 is a composite image of the real environment and plurality of shops 14. Plurality of shops 14 refers to a collection of images of individual structures 16. Preferably, each of the images of individual structures 16 has distinct characteristics of the physical exteriors of actual individual structures 16. Preferably, at least one of individual structures 16 has an interactive link 18 for entryway 20. Interactive link 18 preferably allows the computer operator to interact with individual structure 16 as they traverse digital environment 10. Digital environment 10 preferably includes almost everything found in the real environment such as stores, museums, entertainment centers, professional and office buildings, mall, airports and any other structure found in a real environment. Individual structures 16 are interchangeably referred to as structural images or digital structural images. Preferably, digital environment 10 also includes advertising and interactive advertising.

The computer operator will appear to traverse through digital environment 10 in a seamless appearing manner. Traversing means to move through digital environment 10 by inputting a command into the computer to change the position of the viewer. The input of a command to move or change the view of the computer operator is as simple as moving the computer mouse, or similar input device, in the direction of travel desired. The movement of the computer mouse is well known, but any movement command initiating device to change the scene of the viewer is considered to be part of this method. The computer operator is able to view and traverse all or nearly all of digital environment 10 by moving the mouse cursor or screen pointer in a particular direction. Additionally, the computer operator is able to select interactive functions not directly related to movement on the screen. The interactive functions may allow the computer operator to instantaneously move to a different part of digital environment 10. The terms internet and computer-based network refer to existing systems and future systems linking a plurality of computers and computer operators. More specifically, the terms internet and computer-based network are meant to address a plurality of computer processors or firmware linked and providing the exchange of data.

Seamless appearance means that the computer operator visually perceives digital environment 10 in a continuous, uninterrupted image. Seamless appearance also includes the composite of digital and non-digital images from digital environment 10, rendered to give a computer operator the visual perception of a continuous realistic appearing environmental image. Rendering means the process of producing an interactive image from the many parts, such as pixels of an image, and incorporating the new digital information into digital environment 10.

The computer operator's input movements determine where the computer operator traverses within digital environment 10. Preferably, the computer operator is able to view digital environment 10 as a realistic appearing environment with a full 360° view as the computer operator initiates movement to the right or left. The result is such that the computer operator is able to view digital environment 10 as if standing in the same location in a real environment. Additionally, the computer operator is able to traverse in nearly any direction in relation to the view the computer operator perceives at a given moment.

The computer operator's traversing through digital environment 10 allows browsing of digital environment 10. Browsing appears to be seamless to the computer operator. By browsing, the computer operator is able to view and select items of interest in digital environment 10. Further, the computer operator is presented with numerous interactive opportunities such as advertising. The computer operator selects an item of interest, such as individual structure 16, and proceeds to traverse towards it. Preferably, the computer operator enters individual structure 16 through an entryway 20. Preferably, entryway 20 is the same as interactive link 18. However, there may be multiple interactive links 18 for any given individual structure 16. Additionally, it is preferred that individual structure 16 be segmented into a plurality of individual segments 28. At least one of individual segments 28 is interactive link 18.

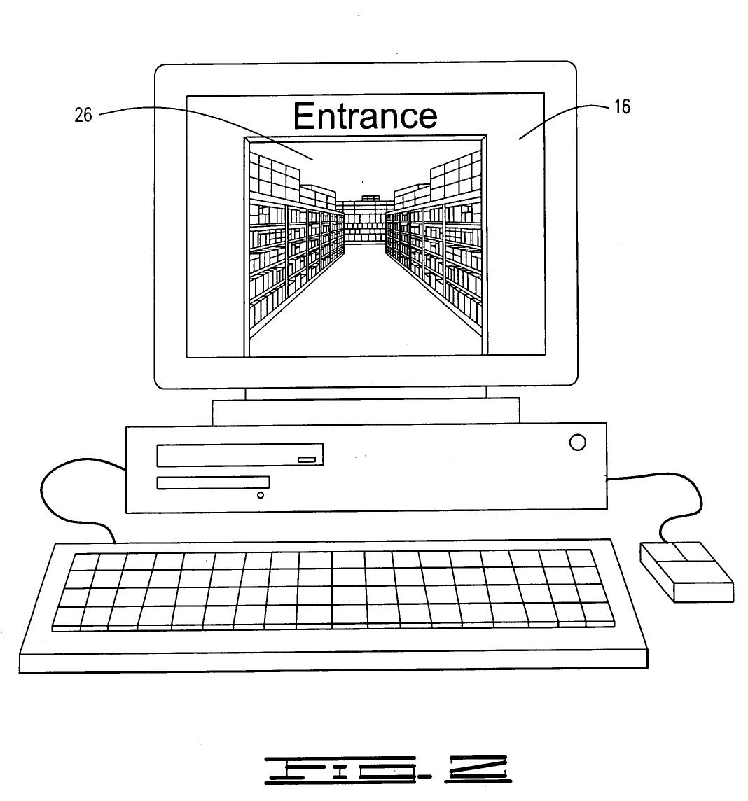

FIG. 2 represents the process of entering a particular individual structure 16 from an exterior view to an interior view. This representation allows the computer operator to visually perceive the entire entryway and part of interior 26 prior to entering individual structure 16. The computer operator subsequently perceives interior 26 of individual structure 16 in a seamless appearing manner. The computer operator will seamlessly perceive interior 26 of internal structure 16 as if they were standing in the entryway of the real structure and view the options presented by individual structure 16.

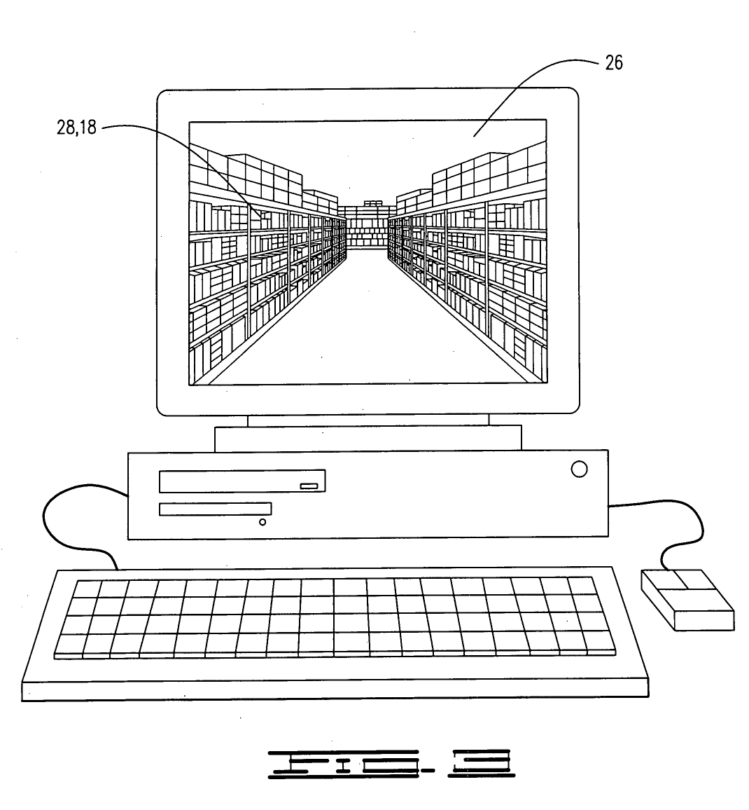

By way of example, FIG. 3 represents a store with numerous items of merchandise on the shelves. In FIG. 2, each of the items is preferably an individual segment 28 with an interactive link 18. The computer operator is able to select, view, read, select items for purchase and checkout or leave. The actions by computer operator appear seamless, as if the computer operator was performing the action in a real store. Repetition of the task of selecting and shopping is up to the personal desires of the computer operator.

Additional considerations for a retail merchant's interactive structure also include the ability to establish customer-service centers. These customer-service centers may operate as live customer-service centers with merchandise exchange/return, tracking/status of outstanding orders, troubleshooting, purchase advisors, help finding an item and other customer-service oriented tasks. A customer-service representative could visually appear in an individual segment 28 interactive link 18 to give the appearance of dealing with a real person.

The computer operator is able to shop and purchase by any number of methods. This invention incorporates the ability for the shopper to choose to shop as if the shopper is in a traditional “brick and mortar” store or to “jump” to other methods of shopping such as a common internet shopping webpage or combination of both methods. The choice to select the common internet shopping method may be implemented by numerous methods, but it may include a seamless transition, an instantaneous transition or a combination thereof.

Digital environment 10 is designed to facilitate modifying, replacing, deleting or inserting a new individual structure 16 image or individual segments 28. Both individual structure 16 images and individual segments 28 are preferably designed to allow updating of digital environment 10. The process involves selecting and removing individual structure 16 image or individual segment 28 which is to be replaced, deleted or modified. The process next involves inserting a new individual structure 16 image, or individual segment 28, into digital environment 10. Once the new images are inserted into digital environment 10, the new digital environment is rendered and reinstalled into the computer network.

Individual segment 28 may also be a source of interactive information or advertising. Using a grocery shopping environment example, the merchandise is interactive and may provide information on nutrition, harvest/manufacture date, the country of origin, recalls on the same or similar products or advertising indicating specials. This same approach can be used for product placement and impulse purchasing traditionally seen in a grocery store. Additionally, the interactive individual segment 28 may also provide additional links for suggested ideas related to the product. Further, the interactive links may play videos or provide links to additional information. All of the interaction and movement within this example and this invention, occur in a seamless appearing manner to the computer operator.

A grocery store was used in the example above. However, this invention is not limited to grocery stores. The same approach can be employed in a mall, a National Park, a professional building, a hospital or any other structure. Another example is to seamlessly traverse a museum environment such as the Louvre in France, or the Smithsonian Air and Space Museum in Washington D.C. Using the museum example, the computer operator will be able to seamlessly perceive, select, view, read and find out more information regarding the museum artifact. Sounds are included to reflect what the computer operator would expect to experience in a museum. As technology permits, it is anticipated that other sensory elements will be able to be seamlessly incorporated such as touch or smell. Additionally, there is the same ability to embed individual segments 28 with one or more interactive links 18 to provide interactive signs, additional information about the art or artifacts, links to other exhibits, links to other museums or any other idea of a museum providing an interactive tour.

Once the computer operator decides to exit individual structure 16, the computer operator will typically exit by traversing the opposite direction from which the computer operator entered the interior 26 of individual structure 16. Alternatively, the computer operator is able to select an option to instantaneously traverse to another location, for example by a pull-down menu. Another alternative is for the computer operator to select a sign indicating an exit to the digital environment or exiting completely from the program. Prior to exiting, the computer operator is able to select and insert a marker which is a link or marker permitting return to the same location at a later date. The computer operator is able to appear to continuously and seamlessly traverse from interior 26 to the exterior of individual structure 16 through interactive link 18 entryway, and out to digital environment 10, as if they were physically exiting the real structure in a real environment. The seamless process of entering and exiting different individual structures 16 is repeated as many times as desired by the computer operator.

One advantage of the current invention is the ability to do low-cost test marketing of a new, remodeled or repositioned business or structure. Because digital environment 10 represents a real environment, the test marketing of a business can be easily accomplished. The test market business creates a virtual structure 17 and inserts it into digital environment 10 without incurring the expense of building a “brick and mortar” structure first. For example, a vacant lot exists in the real environment and in the digital environment 10. The real environment and digital environment 10 is representative of a mixed business and restaurant district near a popular beach. An entrepreneur has the ability to insert a conceptual idea for virtual structure 17 and evaluate it for traffic. Part of the evaluation is of the exterior and interior 26 appearance of virtual structure 17 the entrepreneur creates. Another part of the evaluation is the number of attempts to visit virtual structure 17 by computer operators. Virtual structure 17 can be evaluated for tradedress, trademark, physical location, layout, décor, products/services or any other type of information that will help a new business get started with the best possible chance of success. Virtual structure 17 for this example is only conceptual. However, it is anticipated that a more preferred approach will be to introduce a planned structure 15, which is a result of a new development, remodeling or relocating. In both instances, the businesses are looking for feedback. Virtual structure 17 or planned structure 15 may be inserted into digital environment 10. Digital environment 10 becomes a composite of individual structures 16 representing real structures, images of planned structure 15, images of a virtual structure 17 or combinations thereof. One helpful advantage of virtual structure 17 or planned structure 15 is that the entrepreneur can set a traffic counter and/or a feedback form to find out how virtual structure 17 or planned structure 15 is received.

Creating, producing, placing, selling or leasing advertising that seamlessly integrates with this invention is another major advantage. Advertising in this invention is designed to appear to the computer user in digital environment 10 as it appears in the real world. One advantage is the cost to change the advertising is significantly less. Additionally, the advertiser has the ability to direct traffic to their own webpage or business in a digital environment 10. Advertising is expected to be part of the initial digital environment 10, individual structure 16 or individual segment 28. To facilitate rapid changes, advertising can be structured to appear in individual segment 28. Advertising may take the form of realistic appearing billboards, signs, marquees and other forms of stand-alone advertising communications. Advertising may take the form of targeted or adaptive advertising based upon the habits of the computer operator. Also considered to be part of the invention is the seamless nature of embedded advertising such as streaming video or animated images advertising a product, good or service. The embedded advertising typically is implemented via an interactive individual segment 28. The interactive advertisement may also be an animated advertisement, wherein the animated advertisement is comprised of actual videos, scrolling marquees, flashing signs, interactive video with additional interactive links 18, artificially generated video, moving signs, pop-in signs, fly-in signs or similar types of animation. All of the advertising appears to the computer operator as a seamless, integrated element within the digital environment 10 or individual structure 16.

Some advertisements may only be static signs without interactive link 18. However, most advertisements are preferably interactive and employ interactive link 18. By selecting an advertisement, the computer operator preferably selects interactive link 18. Interactive link 18 may seamlessly traverse the computer operator to another location within digital environment 10 or individual structure 16. Additionally, advertising in interactive link 18 may provide a series of options such as purchasing, locating businesses selling the product, background information on the product or manufacturer or any desired information the computer operator may wish to learn about the advertised item. The same concept of advertising is available within individual structure 16. For example, a business that is also an individual structure 16 may have advertising such as product placement, impulse purchase items, specials throughout the store, at a retail-like checkout or at a catalog section. The advertisements may provide an interactive link 18 to another part of individual structure 16. There is also the ability to advertise a link for a traditional internet pull-down menu or catalog. There is the ability for two or more individual structure 16 images to cross-advertise and provide links to help the computer operator traverse from one individual structure 16 image to another.

One preferred embodiment inserts signs and information links within digital environment 10. Advertising previously discussed may be replaced by information and signs in individual segments 28 and operates identically to the embedded advertising. In this instance, the computer operator selects the particular sign of interest and has the option to be rapidly transported to the new location. Alternatively, the computer operator is able to select a particular item on the sign and find out more information about that particular item.

One advantage of the invention is the integration of a traditional “brick and mortar” structure with the rapid speed of the internet. A computer operator is able to visit digital environment 10 and individual structure 16 before or after visiting the real “brick and mortar” structure. The same computer operator is able to create a favorites list within their web-browser or within the actual digital environment 10 linking them to one or more individual structures. The computer operator may set as many links as they desire. When a computer operator finds something of interest and/or wishes to return to a particular point of digital environment 10 or individual structure 16, the computer operator has the ability to set a marker link that allows them to return to that same point in digital environment 10 or individual structure 16. This marker link may be automated or it may be manual. For example, individual structure 16 is a museum of art. The computer operator is browsing through the museum and has to quit and run an errand. The computer operator may set a marker link to return to the same location they stopped at prior to running their errands.

Additionally, the invention provides for a seamless appearing option to select the emailing of maps of all or a portion of digital environment 10 or individual structure 16. Further, there is the ability to select the option to provide a digital image of a particular location a computer operator wishes to visit. The digital image provides the computer operator with the ability to visually know how the structure appears in the real environment prior to an actual visit.

Another preferred embodiment of this invention is a method for creating a national business' local store within digital environment 10. Often consumer loyalty is based upon familiarity. By providing a means for the computer operator to shop at a local store in digital environment 10, the national business maintains the national control of the products, goods and/or services, yet is able to provide familiar surroundings. This method is similar to the other methods for creating an individual structure 16, yet more of the interactive links are from the national business. Additionally, there is the ability for the computer operator to directly link to and access the national business' website. There is yet another advantage of this inventive method whereby a national business is able to test market the potential of opening a new store in a new market. The national business can build customer loyalty through the nationally provided products, goods and/or services in a local individual structure 16 while more effectively planning the construction of the real store.

Yet another preferred embodiment of this inventive method is a standalone version of at least one digital environment. Preferably, there is a plurality of digital environments contained in a single standalone version. Standalone means a program not needing other programs to operate, other than possibly firmware and an operating system. It is preferred that a standalone system replicate the digital environment as of a certain point in time. It is envisioned to fill the need for computer systems that are not connected to the internet or computer-based systems.

One preferred embodiment of this invention is to lease individual structures 16 and interactive links 18 within digital environment 10 or individual structures 16 to generate revenue. The operator of a website of a particular city or other location could lease space on the website. Similar leasing arrangements can be made for advertisers.

In all embodiments digital environment 10 represents the real environment. The examples previously discussed may not include all of the reference characters of FIGS. 1-3 in that FIGS. 1-3 represent a city and shopping environment. It is clear by the foregoing paragraphs that this inventive method is applicable to other locations, applications or environments and is not meant to be limited by the representations of FIGS. 1-3.

### EXAMPLE

To demonstrate a preferred embodiment of this invention, downtown Manhattan, N.Y. is created in a digital environment which is nearly identical to the real environment. The digital environment is an interactive image allowing a computer operator visiting New York City to find, visit and view places from across the internet or a computer-based network. A local business consortium, arbitrarily referred to as the NYC LBC, maintains the digital environment and assists businesses, museums, government and private facilities with creating its own individual structural digital images. The NYC LBC renders a digital environment by compiling the actual individual structural images.

A visitor to New York City typically wishes to find places to visit, shop, sleep, eat, worship and conduct business. In this example, the visitor, a married man, is the computer operator planning a combined business trip and pleasure trip to New York City. He enters New York City into the search engine of his web browser and sees that the NYC LBC offers a seamless digital tour and trip planner. He selects the NYC LBC program and enters into the New York City digital environment. The first thing he might see is a map of New York City offering choices such as airports, train stations, shopping, lodging, museums, tourist attractions, locations for worship and government facilities. In this example, the map is a hybrid of an advertisement and a sign. If he knows of a particular address he wishes to visit, then he may enter it in an interactive window at the start of the program. If he knows of a particular business, museum, park or other facility by name only, he will be able to enter that same information in the same interactive window. He may begin his digital journey at any location in the digital environment. After selecting a famous department store from an interactive advertisement, he is seamlessly traversed to the front of the store. The chosen method for this seamless movement makes it appear as if he is flying or moving through the streets at a selected rate of speed with the digital images appearing as he “flies-by”. He stops directly in front of the famous department store. The view around him is a nearly identical digital replica of the actual front exterior of the famous department store and surrounding environment. By moving the mouse, he seamlessly traverses to the entryway of the famous department store, experiencing entryway and seeing the interior store as a visitor in reality would see the interior of the store.

Once inside, he chooses to browse. Traversing through the famous department store, he is still able to view all of the merchandise in a clear, seamless manner. While near the perfume counter, he picks up a bottle of perfume and views it. He is able to see where the perfume was produced. By selecting a “more information” icon, a window seamlessly appears. Using the “more information” icon, he is able to seamlessly retrieve information about the product such as price, popularity, manufacturer or any other information digitally available. He is also able to review a current video advertisement having an interactive link to the manufacturer's website.

Continuing to browse the famous department store, he sees an in-store advertisement for a new spring clothing line on the third floor. He moves his mouse cursor to the advertisement and selects it. The advertisement shows the visitor more information regarding the spring clothing line, and provides him with the option to “jump” to the third floor. He selects the “jump” option and is traversed to the third floor. It appears as if he seamlessly stepped from the first floor to the third floor.

He is now wishes to explore the city. Knowing his meeting will be at the Empire State Building, he proceeds toward the exit of the famous department store by selecting a sign indicating “Exit This Way.” He opted to not jump out of the store or the program, which were his other two options. While exiting, he seamlessly views the merchandise in the store and notices the perfect gift for his wife. He impulsively moves to buy the gift by pointing his mouse towards the item. This motion temporarily interrupts the exiting action. After completing his purchase, he exits the famous department store by selecting an option to resume his exit. He seamlessly experiences the visual sensation of departing from the famous department store's front door onto the busy Manhattan street. A sign indicating several selections of buildings and tourist attractions is located in front. One of the selections is the Empire State Building. He moves his mouse cursor and selects the Empire State Building.

The visitor immediately begins traversing the digital environment towards the Empire State Building at a normal walking pace. He is able to view the city as he goes by. He arrives at the Empire State Building in short order. His meeting is on the 46^{th} floor with a venture capital Firm. He “selects” the elevator for the 46^{th} floor. The doors open onto the 46^{th} floor where he is presented with a series of signs directing him to different businesses. He notices the doors to the businesses all appear visually similar. However, because he is using the program, he is able to quickly locate the venture capital firm on one of the signs. He moves his mouse cursor to the particular sign, selects the firm and finds himself seamlessly being traversed down the hall to the correct door. He selects the door for later reference with a marker link. The marker link will return him to this point in the digital environment at any point in time in the future without needing to traverse the entire digital environment again.

He decides to leave the digital environment. He marks his current location and selects an “Exit From Program” link. He is offered the opportunity to have a map, with detailed instructions sent to him for future reference, or to have the map saved as the starting point for his next visit. The map will include the locations where he placed a marker link. In addition to the map, digital images of the exterior of the marked structure will be sent to him to further assist him with locating his marker link locations. Because he is planning on coming back to the program before making his trip, he chooses saving the map as a starting point.

Thus, the present invention is well adapted to carry out the objectives and attain the ends and advantages mentioned as well as those inherent therein. While preferred embodiments of the present invention have been illustrated for the purpose of the present disclosure, changes in the arrangement and construction of parts and the performance of steps can be made by those skilled in the art, which changes are encompassed within the scope and spirit of the present invention as defined by the appended claims.

What is claimed is:

1. A computer network-based seamless image transition method comprising:
traversing a composite digital environment image of a physical location from a real environment;
said digital environment comprising multiple structural images, at least one structure having an interactive link;
selecting a structure with an interactive link; and,
traversing between the digital environment image and the structure having an interactive link in a substantially seamless appearing manner such that the manner of the transition appears as if a computer operator were physically transiting in the real environment.

2. The method of claim 1 further comprising:
a composite digital environmental image that is a of a plurality of individual digital images, wherein the individual digital images comprise a plurality of structures from the real environment; and,
the individual digital images of the composite of digital environmental images are from the group consisting of images of a real structure, images of a planned structure, images of a virtual structure or combinations thereof.

3. The method of claim 2 further comprising:
the images of the virtual structure rendered to provide a realistic appearing, panoramic view of the real environment with the images of the virtual structure; and
a computer operator provided with the a capability to view the images of the virtual structure in an apparently seamless manner as if the computer operator were in a real structure in the real environment.

4. The method of claim 3, wherein the computer operator may move in any direction in relation to the computer operator's view in a seamless appearing manner.

5. The method of claim 1, further comprising the structure where each structure has a visible entryway within an individual digital image of the structure and said visible entryway is an interactive entryway for the at least one structure having an interactive link.

6. The method of claim 5, further comprising:
traversing through the interactive entryway by the computer operator in a seamlessly appearing manner as if the operator were walking through a real entryway;
perceiving an interior of the at least one interactive structure as if the computer operator is entering a real structure and perceiving the interior;
moving around within the at least one interactive structure in a seamless-like manner as if the computer operator were moving around within a real structure; and,
exiting the at least one interactive structure seamless appearing manner, wherein the visual appearance to the computer operator is one where the computer operator has a visual experience of exiting the entryway as is found in the real environment.

7. The method of claim 6, wherein the computer operator interacts with at least one item the computer operator perceives within the at least one interactive structure.

8. The method of claim 7, wherein the at least one interactive structure is a retail store and the item further comprises merchandise, signs and a means to actively perform a retail checkout.

9. The method of claim 8, wherein interaction with the merchandise further comprises being able to select, view, read and select items for purchase.

10. The method of claim 7, wherein the at least one interactive structure is a museum.

11. The method of claim 10, wherein the item is a museum piece that the operator may select, view, read and electronically obtain additional information regarding the museum piece.

12. The method of claim 7, wherein the item is a museum piece that the operator may select an auditory interactive component.

13. The method of claim 1, wherein exiting is in response to a visual sign within an individual digital image.

14. The method of claim 13, wherein exiting is in response to an interactive menu.

15. The method of claim 1, wherein the operator has an ability to create a link to the structure the operator is currently within.

16. The method of claim 1, wherein the digital image has a capability for advertising, wherein the advertising is further comprises:
realistic appearing billboards, signs, marquees and other forms of stand-alone advertising communications; and,
wherein the advertising has the capability to provide links to the advertised item.

17. The method of claim 1, wherein the operator is further able to hear an environmentally appropriate sound for an area being traversed.

18. The method of claim 1, wherein the operator is able to put a marker providing an electronic link back to that particular location in the digital environment.

19. A seamless web image traversing method comprising:
an operator using a computer to view a digital environment via an internet link, the digital environment comprising a digital image of a real environment, wherein the digital environment further comprises a plurality of a digital structural images, the digital structural images have discernable characteristics of their physical exteriors, at least one of the digital structural images has an interactive digital structural image;
traversing the digital environmental in a continuous manner, wherein the traversing in the continuous manner is a substantially visually seamless appearing motion to said operator, wherein the computer operator is able to view the digital environmental in a realistic appearing environment with a full 360 degree view and said operator is able to view the digital environmental as if they were physically present within the digital environmental;
said operator selecting an interactive digital structural image from within the digital environmental, wherein the interactive digital structural image has an interactive entryway;
traversing through the interactive entryway of the interactive digital structural image in a continuously seamless appearing manner from the exterior to an interior, said operator visually perceives the interior of a digital structural image as if physically traversing through an entryway of an actual physical structure in the real environment;
viewing the interior of the digital structural image, wherein said operator perceives a plurality of items, the plurality of items have at least one interactive item;
interacting with the interactive item in the interior of the digital structural image, wherein the interaction appears substantially continuously seamless to said operator and is repeated until the computer operator chooses to discontinue the interacting;
exiting the interior of the physical structure, wherein said operator is able to appear to substantially continuously seamlessly traverse from the interior to the exterior of the digital structural image through the interactive entryway out to the digital environment as if physically exiting the real structure in a real environment; and,
repeating with as many interactive digital structural images as desired.

20. The method of claim 19 further comprising:
the digital environment that is a of a plurality of individual digital images, the digital environment comprising a plurality of structures resembling a real location; and,
the individual digital images of the digital environment of digital images are from the group consisting of images of a real structure, images of a planned structure, images of a virtual structure or combinations thereof.

21. The method of claim 20 further comprising:
the images of the virtual structure rendered to provide a realistic appearing, panoramic view of the real environment with the images of the virtual structure; and
said operator provided with the a capability to view the images of the virtual structure in an apparently seamless manner as if said operator were in a real structure in the real environment.

22. The method of claim 21, wherein said operator may move in any direction in relation to said operator's view in a seamless appearing manner.

23. The method of claim 19, wherein the interactive digital structural image is a retail store and the item further comprises merchandise, signs and a means to actively perform a retail checkout.

24. The method of claim 23, wherein interaction with the merchandise further comprises being able to select, view, read and select for purchase.

25. The method of claim 19, wherein the interactive digital structural image is a museum.

26. The method of claim 25, wherein the item is a museum piece that the operator may select, view, read and electronically obtain additional information regarding the museum piece.

27. The method of claim 19, wherein said operator has an ability to create a marker link to the interactive digital structural image while said operator is within the structure.

28. The method of claim 19, wherein the digital environment has a capability for displaying an advertisement.

29. The method of claim 28, wherein the advertisement further comprises:
realistic appearing billboards, signs, marquis and other forms of stand-alone advertising communications; and,
wherein the advertising has the capability to provide links to the advertised item.

30. The method of claim 19, wherein the interactive digital structural image is digitally segmented to provide a subset of interactive segments, the subset of interactive segments comprises the group of interactive capabilities from the group consisting of displaying an interactive sign, displaying an interactive subset advertisement or a combination thereof.

31. The method of claim 30, wherein the interactive sign further comprises:
realistic appearing signs with interactive links taking said operator to other locations within an interactive digital structural image business, wherein the other locations further comprise:
a retail-like checkout for the interactive digital structural image business;
a catalog section for the interactive digital structural image business;
an online pull-down menu for traditional internet interactive business;
a rapid exit to the digital environment starting point; and,
a jump to a co-participating interactive digital structural image business.

32. The method of claim 30, wherein the interactive subset advertisement further comprises hotlinks to the advertised item.

33. The method of claim 19, wherein said operator has an option to link to an interactive digital structural image business' traditional internet shopping link.

34. The method of claim 19, wherein said operator has an option to hotlink to an interactive digital structural image business' traditional catalog link.

35. The method of claim 19 further comprising:
selecting a digital image within a digital environment, the digital environment is further comprised of a plurality of individual digital images; wherein the digital image is segmented into a subset of digital images and each individual subset of the digital images is individually replaceable;
removing a current digital image;
inserting a new digital image into the digital environment; and
rendering a new digital environment.

36. A method for creating a national business' local store within a digital environment comprising:
digitally imaging the national business' local store;
creating interactive links to specific items within the store; and,
linking the store with a national business' national website.

37. A method for test marketing a potential business within a digital environment comprising:
creating a digital image of a potential business to include all facades, entryways and interiors, wherein the interior also includes at least one digital image of a potential inventory;
replacing a segmented digital image within a digital environment with the digital image of a potential business;
rendering a new digital environment, wherein the digital image of a potential business will appear to seamlessly integrate with the digital environment for a computer operator; and,
monitoring traffic to the digital image of a potential business by using a traffic counter on the link to the digital image.

38. The method of claim 37, wherein the segmented digital image being replaced is a vacant lot or a structure to be replaced in a real environment.

39. The method of claim 37, wherein the at least one digital image of the potential inventory is interactive.
